(19) United States
(12) Patent Application Publication
(10) Pub. No.: US 2009/0309964 A1
(43) Pub. Date: Dec. 17, 2009

(54) PORTABLE VIEWING DEVICE

(76) Inventor: Sidney Louis Schrage, Red Bluff, CA (US)

Correspondence Address: ADVANTIA LAW GROUP, 9035 SOUTH 1300 EAST, SUITE 200, SANDY, UT, 84094, US

(21) Appl. No.: 12/405,416

(22) Filed: Mar. 17, 2009

Related U.S. Application Data
(60) Provisional application No. 61/061,465, filed on Jun. 13, 2008.

(51) Int. Cl. H04N 7/18

(52) U.S. Cl. 348/82; 348/E07.085; 348/373; 348/207.1

(57) ABSTRACT

There is a portable viewing device for viewing difficult to view areas, wherein the portable viewing device includes a telescoping wand. The wand includes a body housing. The body housing includes a wireless transmission module, a first end including a selectably rechargeable power module configured to dock with a recharge module and a second end. The portable viewing device also includes a color camera coupled by a ball and joint swivel camera mount to the first end of the telescoping wand. The portable viewing device further includes a display device in communication with the color camera and configured to display visual information therefrom. The portable viewing device also includes a docking station having a recharge module, coupled to the display device and configured to selectably couple to the first end of the telescoping wand, thereby allowing the wand to dock thereto and be recharged.

### CROSS-REFERENCE TO RELATED APPLICATIONS

This invention claims priority, under 35 U.S.C. §120, to the U.S. Provisional Patent Application No. 61/061,465 to Sidney Louis Schrage filed on Jun. 13, 2008, which is incorporated by reference herein.

### FIELD OF THE INVENTION

The present invention relates to cameras, specifically to a portable viewing device.

### DESCRIPTION OF THE RELATED ART

A camera is a device used to capture images, either as still photographs or as sequences of moving images (movies or videos). The term comes from the Latin camera obscura for “dark chamber” for an early mechanism of projecting images where an entire room functioned as a real-time imaging system; the modern camera evolved from the camera obscura. Cameras may work with the light of the visible spectrum or with other portions of the electromagnetic spectrum. A camera generally consists of an enclosed hollow with an opening (aperture) at one end for light to enter, and a recording or viewing surface for capturing the light at the other end. Most cameras have a lens positioned in front of the camera's opening to gather the incoming light and focus all or part of the image on the recording surface. The diameter of the aperture is often controlled by a diaphragm mechanism, but some cameras have a fixed-sized aperture.

Traditional cameras capture light onto photographic film or photographic plate. Video and digital cameras use electronics, usually a charge coupled device (CCD) or sometimes a CMOS sensor to capture images which can be transferred or stored in tape or computer memory inside the camera for later playback or processing. Cameras that capture many images in sequence are known as movie cameras or as cine cameras in Europe; those designed for single images are still cameras. However these categories overlap, as still cameras are often used to capture moving images in special-effects work and modern digital cameras are often able to trivially switch between still and motion recording modes. A video camera is a category of movie camera that captures images electronically (either using analogue or digital technology). A stereo camera can take photographs that appear “three-dimensional” by taking two different photographs that can be combined to create the illusion of depth in the composite image. Stereo cameras for making 3D prints or slides have two lenses side by side. Stereo cameras for making lenticular prints have 3, 4, 5, or even more lenses. Some film cameras feature date imprinting devices that can print a date on the negative itself.

However, most cameras are difficult to position within close quarters, such as in between an automobile engine, behind a piece of furniture, or any other position with limited space. Some improvements have been made in the field. Examples of references related to the present invention are described below, and the supporting teachings of each reference are incorporated by reference herein:

U.S. Pat. No. 6,091,453, issued to Coan et al., discloses a simple, rugged, preferably hand-held video camera and light source useful for inspection of a remote or obstructed field of view. The invention is particularly adapted for use by automobile mechanics and others, as a replacement for the mechanics' mirrors presently in use. The apparatus comprises a shaft, a support, a pivot, a miniature video camera, and a light source. The shaft has a handle at one end and supports the camera and light source on a support pivoted to its other end. The shaft can be bent to a particular shape readily, then substantially hold that shape as it is used. The light source can be at least one electric-powered illuminating lamp. The preferred light source includes two or more illuminating lamps distributed around the camera lens to reduce shadows. A preferred light source is a series of infrared LED's. The present apparatus has several advantages, particularly inexpensive, versatile construction and a superior, shadow-free light source.

U.S. Pat. No. 5,579,071, issued to Wetzel et al., discloses a camera stabilizing support apparatus includes motorized “x-y translation” of one or more components of the camera equipment, such that no mechanical forces are imparted to the overall system which would adversely affect the angular position of the gimbaled mass, synchronous control of the motion of lower masses of the camera stabilizing support apparatus so that both dynamic and static balance is preserved throughout the range of motion, and an adjustable gimbal mechanism which serves to isolate the system's equipment support from the support arm extending from the operator's body harness which provides both coarse and fine location adjustment, and provides positive self-centering for these gimbal locking elements so that no clamp distortion occurs.

U.S. Pat. No. 4,530,580, issued to Ueda et al., discloses a telescopic extender for supporting a compact camera includes a head member to be attached to the camera, a grip to be held and a telescopic rod member connecting the head member to the grip. A screw member is supported by the head member in a manner that the screw member is rotatable about the axis perpendicular to an extending and collapsing direction of the telescopic rod. The grip can accomodate therein the telescopic rod when the telescopic rod is completely collapsed.

U.S. Pat. No. 7,252,441, issued to Chapman, discloses a telescoping camera crane has mechanical drive and camera platform leveling systems, allowing for water resistant or submerged operation. Telescoping sections of the crane arm are driven by a hydraulic system, for smooth and near silent extension and retraction movement. The telescoping sections of the crane arm have a slight upward curvature, to compensate for deflection the arm, thereby improving performance. Electronic and mechanical stopping systems allow the camera platform to be smoothly, accurately, and reliably positioned. Camera platform levelling and stabilizing systems keep the camera level.

U.S. Pat. No. 7,128,419, issued to Harris, discloses a remote camera positioning and control system is disclosed that permits a sole operator to use and support a camera out of arm's reach. The system can include a handle module that incorporates, for example, an axially and rotationally moveable grip and a proximal handle grip ring and control cage for surrounding a camera control, such as a joystick.

U.S. Pat. No. 6,384,863, issued to Bronson, discloses an ergonomically designed digital camera includes a hand grip that can be comfortably held by one hand and a lens assembly that is positioned above and connected to the hand grip by a telescoping and rotating device. The hand grip has one or more buttons including a shutter trigger located on a front surface of the hand grip, and one or more command control buttons located on a back surface of the hand grip. The lens assembly includes a memory device that stores digital images or videos and a micro display viewfinder located on a back surface of the lens assembly. The lens assembly may also include a fill-in flash and/or a telescoping flash.

U.S. Pat. No. 5,989,184, issued to Blair, discloses an apparatus for digital colposcopy and videography comprises a digital imaging camera that is operably coupled to the optical path of the digital colposcope by means of a beam splitter so that a digital image of the cervico-vaginal tissue can be captured. The digital imaging camera and digital colposcope are mounted to one end of an articulating arm of the apparatus. A digital processing means is operably connected to the digital imaging camera to create a digital image. The digital processing means is housed in a stand of the assembly.

U.S. Patent Application Publication No.: 2007/0109410, by Siew, discloses an apparatus for audio reproduction and image capture having a housing with a first portion and a second portion. The first portion is moveable relative to the second portion between a first position and a second position. There is at least one loudspeaker driver mounted in the second portion for audio reproduction, and a web camera mounted to the first portion moveable at least laterally relative to the first portion. The first portion is adjustable when in the second position for aiming of the web camera.

The inventions heretofore known suffer from a number of disadvantages which include being difficult to use, being expensive, being limited in application, being limited in versatility, being limited in adaptability, being bulky, being ineffective, and being inefficient.

What is needed is a portable viewing device that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available portable viewing devices. Accordingly, the present invention has been developed to provide a portable viewing device to help view difficult to view areas.

In one embodiment of the invention, there is a portable viewing device for viewing difficult to view areas, wherein the portable viewing device may include a telescoping wand. The telescoping wand may be configured to selectably extend and may also include a body housing. The body housing may include a wireless transmission module configured to transmit visual information wirelessly. The body housing may also include a first end; and a second end; wherein the first end may include a selectably rechargeable power module configured to dock with a recharge module. The telescoping wand may also include a power module coupled to the body housing and configured to provide power to the components and modules of the portable viewing device. The portable viewing device may additionally include a color camera coupled by a ball and joint swivel camera mount to the first end of the telescoping wand and may be configured to rotate 180 degrees about the telescoping wand.

The portable viewing device may include a display device in communication with the color camera and may be configured to display visual information therefrom. The display device may include a storage module configured to store visual and audio information. In addition, the display device may also include a power module configured to provide power thereto. The portable viewing device may also include a docking station having a recharge module, coupled to the display device and configured to selectably couple to the first end of the telescoping wand, thereby allowing the wand to dock thereto and be recharged.

Furthermore, the portable viewing device may include an audio module disposed within the body housing and configured to record audio information. The portable viewing device may also include an adjustment mechanism having a locking mechanism coupled between the camera and the wand configured to secure the telescoping wand in an angled configuration. In addition, the portable viewing device may include an adapter module and a plurality of data transmission socket modules, configured to transmit visual and audio information to a display device. Moreover, the portable viewing device may additionally include a carrying case configured to secure the telescoping wand, color camera, display device, and docking station for transportation of the portable viewing device.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawing(s). It is noted that the drawings of the invention are not to scale. The drawings are mere schematics representations, not intended to portray specific parameters of the invention. Understanding that these drawing(s) depict only typical embodiments of the invention and are not, therefore, to be considered to be limiting its scope, the invention will be described and explained with additional specificity and detail through the use of the accompanying drawing(s), in which:

FIG. 1 is a front perspective view of a portable viewing device, according to one embodiment of the invention;

FIG. 2 is a side elevational view of a telescoping wand of a portable viewing device, according to one embodiment of the invention; and

FIG. 3 is a module diagram of a portable viewing device, according to one embodiment of the invention.

### DETAILED DESCRIPTION OF THE INVENTION

For the purposes of promoting an understanding of the principles of the invention, reference will now be made to the exemplary embodiments illustrated in the drawing(s), and specific language will be used to describe the same. It will, nevertheless, be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of programmable or executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module and/or a program of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

The various system components and/or modules discussed herein may include one or more of the following: a host server or other computing systems including a processor for processing digital data; a memory coupled to said processor for storing digital data; an input digitizer coupled to the processor for inputting digital data; an application program stored in said memory and accessible by said processor for directing processing of digital data by said processor; a display device coupled to the processor and memory for displaying information derived from digital data processed by said processor; and a plurality of databases. As those skilled in the art will appreciate, any computers discussed herein may include an operating system (e.g., Windows Vista, NT, 95/98/2000, OS2; UNIX; Linux; Solaris; MacOS; and etc.) as well as various conventional support software and drivers typically associated with computers. The computers may be in a home or business environment with access to a network. In an exemplary embodiment, access is through the Internet through a commercially-available web-browser software package.

The present invention may be described herein in terms of functional block components, screen shots, user interaction, optional selections, various processing steps, and the like. Each of such described herein may be one or more modules in exemplary embodiments of the invention. It should be appreciated that such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, the software elements of the present invention may be implemented with any programming or scripting language such as C, C++, Java, COBOL, assembler, PERL, Visual Basic, SQL Stored Procedures, AJAX, extensible markup language (XML), with the various algorithms being implemented with any combination of data structures, objects, processes, routines or other programming elements. Further, it should be noted that the present invention may employ any number of conventional techniques for data transmission, signaling, data processing, network control, and the like. Still further, the invention may detect or prevent security issues with a client-side scripting language, such as JavaScript, VBScript or the like.

Additionally, many of the functional units and/or modules herein are described as being “in communication” with other functional units and/or modules. Being “in communication” refers to any manner and/or way in which functional units and/or modules, such as, but not limited to, computers, laptop computers, PDAs, modules, and other types of hardware and/or software, may be in communication with each other. Some non-limiting examples include communicating, sending, and/or receiving data and metadata via: a network, a wireless network, software, instructions, circuitry, phone lines, internet lines, satellite signals, electric signals, electrical and magnetic fields and/or pulses, and/or so forth.

As used herein, the term “network” may include any electronic communications means which incorporates both hardware and software components of such. Communication among the parties in accordance with the present invention may be accomplished through any suitable communication channels; for example, a telephone network, an extranet, an intranet, Internet, point of interaction device (point of sale device, personal digital assistant, cellular phone, kiosk, etc.), online communications, off-line communications, wireless communications, transponder communications, local area network (LAN), wide area network (WAN), networked or linked devices and/or the like. Moreover, although the invention may be implemented with TCP/IP communications protocols, the invention may also be implemented using IPX, Appletalk, IP-6, NetBIOS, OSI or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997); and LOSHIN, TCP/IP CLEARLY EXPLAINED (1997), the contents of which are hereby incorporated by reference.

Reference throughout this specification to an “embodiment,” an “example” or similar language means that a particular feature, structure, characteristic, or combinations thereof described in connection with the embodiment is included in at least one embodiment of the present invention. Thus, appearances of the phrases an “embodiment,” an “example,” and similar language throughout this specification may, but do not necessarily, all refer to the same embodiment, to different embodiments, or to one or more of the figures. Additionally, reference to the wording “embodiment,” “example” or the like, for two or more features, elements, etc. does not mean that the features are necessarily related, dissimilar, the same, etc.

Each statement of an embodiment, or example, is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The features, functions, and the like described herein are considered to be able to be combined in whole or in part one with another as the claims and/or art may direct, either directly or indirectly, implicitly or explicitly.

As used herein, “comprising,” “including,” “containing,” “is,” “are,” “characterized by,” and grammatical equivalents thereof are inclusive or open-ended terms that do not exclude additional unrecited elements or method steps. “Comprising” is to be interpreted as including the more restrictive terms “consisting of” and “consisting essentially of.”

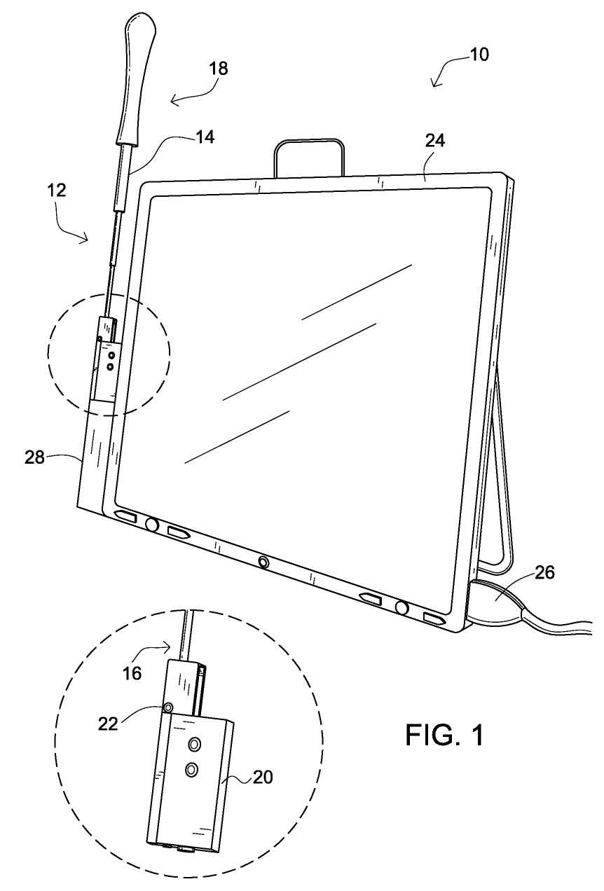

FIG. 1 illustrates a front perspective view of a portable viewing device 10, according to one embodiment of the invention, wherein the portable viewing device 10 is configured to view difficult to view areas. The portable viewing device 10 includes a telescoping wand 12; wherein the telescoping wand 12 is configured to selectably extend. The telescoping wand may include a plurality of fitted concentric cylinders configured to slideably couple to each other. The telescoping wand 12 includes a body housing 14; wherein the body housing 14 includes a first end 16 and a second end 18. The portable viewing device 10 also includes a color camera 20 coupled by a ball and joint swivel camera mount 22 to the first end 16 of the telescoping wand 12. The ball and joint swivel camera mount is configured to rotate 180 degrees (half sphere or half circle) about the telescoping wand 12.

The portable viewing device 10 additionally includes a display device 24 in communication with the color camera 20 and configured to display visual information therefrom. The color camera and the display device may be in communication through a wireless data transmission system, such as but not limited to Bluetooth, radio, infrared, short range magnetic induction, and the like. Accordingly, each of the color camera and the display device may be in communication with wireless transmission/reception modules as appropriate to facilitate communication therebetween. The color camera and the display device may be coupled together and in communication through a wired connection such as but not limited to a data line. One non-limiting example of a wireless transmission/reception modules, may be a wireless data module described in U.S. Pat. No. 5,684,828, issued to Bolan et al., which is hereby incorporated for its supported teachings.

The display device 24 includes a power module 26 configured to provide power thereto. Such may include a rechargeable battery, a power supply, a solar power supply, and etc.. The portable viewing device 10 further includes a docking station 28, coupled to the display device 24 and configured to selectably couple to the color camera 20, thereby allowing the wand 12 to dock thereto and be recharged. The color camera 20 may also be in wireless communication with the display device 24 or coupled to the docking station 28 to display visual information.

In a prophetic exemplary operation of one embodiment of the invention, a mechanic couples a color camera to the ball and joint swivel camera mount. The mechanic then turns on the telescoping wand and adjusts the ball and joint swivel color camera to an angled configuration, thereby viewing images from the end of the telescoping wand. The mechanic may then view difficult to see areas, such as, but not limited to portions of an automobile engine. The mechanic may adjust the ball joint swivel camera mount to a variety of different angles to further display difficult to view areas. The mechanic may also adjust the body housing of the telescoping wand, wherein the length of the wand is adjusted. The camera transmits, wirelessly, the visual information to the display device, thereby displaying the image or images of a difficult to view area. In addition, the mechanic may couple the camera to the docking station, thereby displaying the image or images on the display device. The mechanic may also charge the power module of the camera on the docking station.

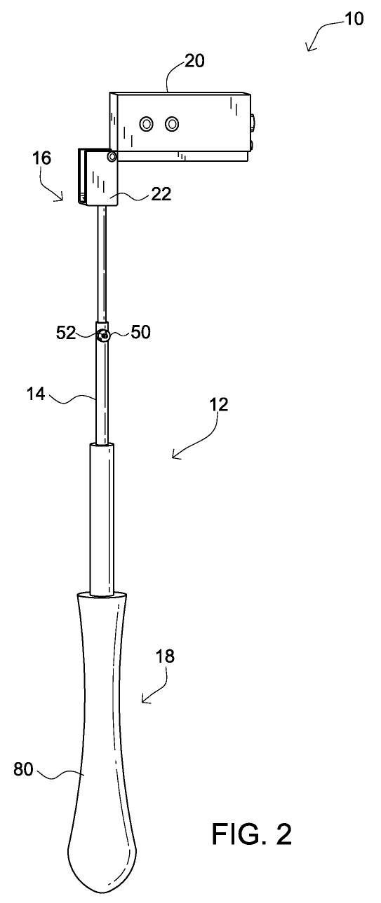

FIG. 2 illustrates a side elevational view of a telescoping wand 12 of a portable viewing device 10, according to one embodiment of the invention, wherein the portable viewing device 10 is configured for viewing difficult to view areas. The portable viewing device 10 includes a telescoping wand 12. The telescoping wand 12 is configured to selectably extend and additionally includes a body housing 14. The body housing 14 includes a first end 16 and a second end 18. The portable viewing device 10 also includes a color camera 20 coupled by a ball and joint swivel camera mount 22 to the first end 16 of the telescoping wand 12. The ball and joint swivel camera mount 22 is configured to rotate 180 degrees about the telescoping wand 12. The portable viewing device 10 further includes an adjustment mechanism 50 having a locking mechanism 52 coupled between the camera 20 and a handle 80 of the telescoping wand 12. The adjustment mechanism 50 is configured to secure the telescoping wand 12 in an angled configuration such that a particular orientation of the camera may be positioned and locked in place. An adjustment mechanism may be a selectably adjustable tightening device such as but not limited to a screw, configured to selectably alter a friction fit between portions of the joint. In another embodiment, an adjustment mechanism may include a pin selectably coupleable through a plurality of matching apertures in portions of the joint.

In operation of one embodiment of the invention, a user couples a color camera to the ball and joint swivel camera mount. The user then turns on the telescoping wand and color camera. The user may adjust the ball joint swivel camera mount to a variety of different angles. In addition, the user may also adjust the body housing of the telescoping wand, wherein the length of the wand may be adjusted. Furthermore, the user may adjust the adjustment mechanism, thereby securing the camera in a variety of angled configurations. The user then views a difficult to view area, such as, but not limited to a user's back or difficult to view area. The camera transmits the visual information, wirelessly, to the display device; or the user may couple the camera to the docking station, wherein the user thereby displays the image or images on the display device. The user may also charge the camera on the docking station.

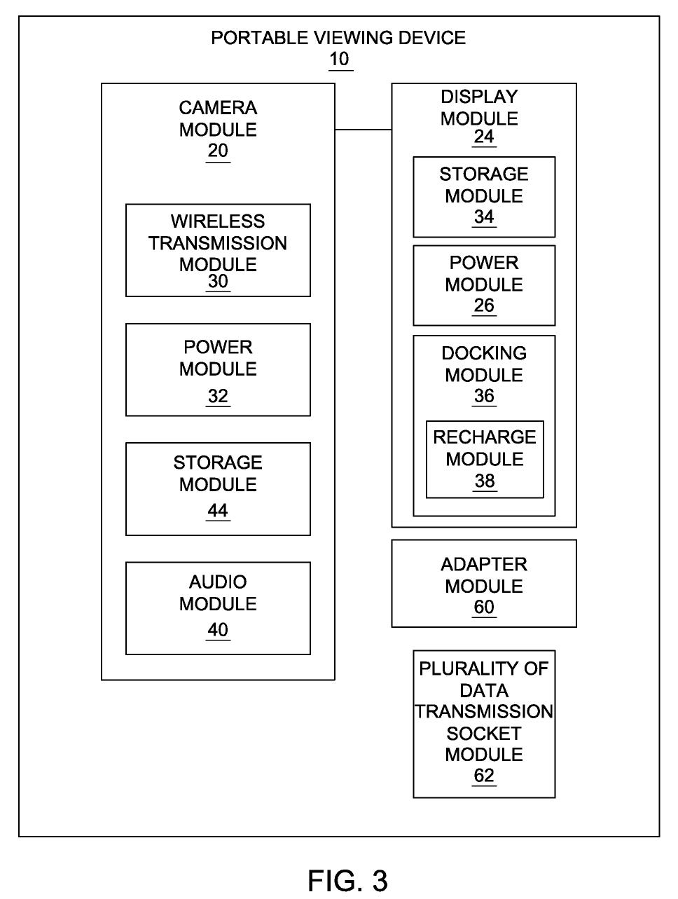

FIG. 3 illustrates a module diagram of a portable viewing device 10, according to one embodiment of the invention. The portable viewing device 10 includes a camera module 20; wherein the camera module includes a wireless transmission module 30 configured to transmit visual information wirelessly. Such may be by radio, microwave, infrared, magnetic induction, and the like. The camera module also includes a power module 32 coupled to the body housing and configured to provide power to the components and modules of the camera module 20. The camera module further includes an audio module 40 disposed within the body housing and configured to record audio information. Moreover, the camera module 20 includes a storage module 44 disposed with the body housing and configured to store audio and visual information, such as, but not limited to, RAM (Random Access Memory) module, a data cache, a USB data storage device, and the like. Data may be cached in the storage device prior to, or coinciding with, data transmission. There may be a control device configured to selectably capture and store data from the camera, such that a user may be enabled to capture particular images for later transmission or for marking, such as, but not limited to providing a meta-tag thereto.

The portable viewing device 10 also includes a display module 24 in communication with the camera module 20 and configured to display visual information therefrom. The display module may be an LCD display, electronic paper, a CRT monitor, and/or any combination thereof and/or the like. The display module 24 includes a storage module 34 configured to store visual and audio information. Such may include one or more solid state memory devices such as sticks of RAM, USP hard drives, magnetic hard drives, and the like. The display module 24 also includes a docking module 36 having a recharge module 38, coupled to the display module 24, thereby allowing the camera to dock thereto and be recharged. In addition, the display module includes a power module 26 configured to provide power thereto. One non-limiting example of a recharge module may be a recharging system as described in U.S. Pat. No. 5,844,472, issued to Lee, which is hereby incorporated for its supported teachings.

Furthermore, the portable viewing device 10 includes an adapter module 60 and a plurality of data transmission socket modules 62 such as USB sockets, serial port sockets, parallel port sockets, memory card sockets, and the like, configured to transmit visual and audio information to a memory device or a display device that does not receive a wireless transmission nor does it include a docking station. The adapter module 60 may be disposed on the handle of the portable viewing device 10; wherein the plurality of data transmission socket module 62 may be coupled thereto, thereby coupling the portable viewing device 10 to the display device and displaying the visual and audio information thereon. Moreover, the portable viewing device 10 may additionally include a carrying case configured to secure the telescoping wand 12, color camera 20, display device 24, and docking station 28 for transportation of the portable viewing device. One non-limiting example of an adapter module may be a communication socket as described in U.S. Pat. No. 6,920,501, issued to Chu et al., which is hereby incorporated for its supported teachings. One non-limiting example of a plurality of data transmission socket modules may be a plurality of migrateable sockets, described in U.S. Pat. No. 6,920,501, issued to Chu et al., which is hereby incorporated for its supported teachings.

In operation of one embodiment of the invention, a user couples a color camera to the ball joint swiveling camera mount. The user then turns on the camera and telescoping wand and adjusts the ball joint swivel camera mount, adjustment mechanism, and/or the body housing of the telescoping wand to a variety of angled configurations. The camera module may transmit, wirelessly, to the display device to display the visual and/or audio information. The user may also couple the portable viewing device to the docking station thereby displaying the image or images on the display device. The user may charge the portable viewing device on the docking station. The user may also record audio information with the audio module and store the visual and audio information in the storage module of the camera module. In addition, the user may couple the adapter module to a display device, that does not include a wireless transmission module or a docking module, to display visual and audio information therefrom.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claims rather than by the foregoing description. All changes which come within the meaning and range of equivalency of the claims are to be embraced within their scope.

For example, although FIG. 1 illustrates a display device, one skilled in the art would appreciate that the display device may be a variety of display modules. Non-limiting examples of a display device may be a phone, a television, a storage device, a monitor, etc., and still perform its intended function.

It is envisioned, that one skilled in the art would appreciate, that the recharge module may couple to the second end of the portable viewing device and still perform its intended function.

It is also envisioned, that one skilled in the art would appreciate, that the ball and swivel camera mount may be a plurality of camera mounts configured to couple the camera to a telescoping wand and allow for 180 degrees of rotational freedom and still perform its intended function. Rotational freedom provided by a joint may be greater than or less than 180 degrees.

It is expected that there could be numerous variations of the design of this invention. An example is that the telescoping wand may vary in size, shape, design, configuration, color, rotational freedom, and still perform its intended function.

Finally, it is envisioned that the components of the device may be constructed of a variety of materials, such as, but not limited to: plastic, plastic composite, rubber, rubber composite, metal, metal alloys, glass, and still perform its intended function.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims. Further, it is contemplated that an embodiment may be limited to consist of, or to consist essentially of, one or more of the features, functions, structures, methods described herein.

What is claimed is:

1. A portable viewing device for viewing difficult to view areas, comprising:
a) a telescoping wand configured to selectably extend and having:
1) a body housing including a wireless transmission module configured to transmit visual information wirelessly;
2) a first end; and
3) a second end; wherein the first end includes a selectably rechargeable power module configured to dock with a recharge module;
b) a color camera coupled by a ball and joint swivel camera mount to the first end of the telescoping wand configured to rotate 180 degrees about the wand;
c) a display device in communication with the color camera and configured to display visual information therefrom; and
d) a docking station including a recharge module, coupled to the display device and configured to selectably couple to the first end of the telescoping wand, thereby allowing the wand to dock thereto and be recharged.

2. The device of claim 1, wherein the telescoping wand further includes an audio module disposed within the body housing and configured to record audio information.

3. The device of claim 1, further comprising an adjustment mechanism having a locking mechanism coupled between the camera and the wand configured to secure the telescoping wand in an angled configuration.

4. The device of claim 1, wherein the display device includes a storage module configured to store visual and audio information.

5. The device of claim 1, wherein the telescoping wand further includes a power module coupled to the body housing and configured to provide power to the components and modules of the portable display device.

6. The device of claim 1, wherein the display device further includes a power module configured to provide power thereto.

7. The device of claim 1, wherein the portable viewing device further includes an adapter module and a plurality of data transmission socket modules, configured to transmit visual and audio information to a display device.

8. A portable viewing kit for viewing difficult to view areas, comprising:
a) a telescoping wand configured to selectably extend and having:
1) a body housing including a wireless transmission module configured to transmit visual information wirelessly;
2) a first end; and
3) a second end; wherein the first end includes a selectably rechargeable power module configured to dock with a recharge module;
b) a color camera coupled by a ball and joint swivel camera mount to the first end of the telescoping wand configured to rotate 180 degrees about the wand;
c) a display device in communication with the color camera and configured to display visual information therefrom;
d) a docking station including a recharge module, coupled to the display device and configured to selectably couple to the first end of the telescoping wand, thereby allowing the wand to dock thereto and be recharged; and
e) a carrying case configured to secure the telescoping wand, color camera, display device, and docking station for transportation of the portable viewing kit.

9. The kit of claim 8, wherein the telescoping wand further includes an audio module disposed within the body housing and configured to record audio information.

10. The kit of claim 9, further comprising an adjustment mechanism having a locking mechanism coupled between the camera and the wand configured to secure the telescoping wand in an angled configuration.

11. The kit of claim 10, wherein the display device includes a storage module configured to store visual and audio information.

12. The kit of claim 11, wherein the telescoping wand further includes a power module coupled to the body housing and configured to provide power to the components and modules of the portable viewing device.

13. The kit of claim 12, wherein the display device further includes a power module configured to provide power thereto.

14. The kit of claim 13, wherein the portable viewing kit further includes an adapter module and a plurality of data transmission socket modules, configured to transmit visual and audio information to a display device.

15. A portable viewing device for viewing difficult to view areas, comprising:
a) a telescoping wand configured to selectably extend and having:
1) a body housing including a wireless transmission module configured to transmit visual information wirelessly;
2) a first end; and
3) a second end; wherein the first end includes a selectably rechargeable power module configured to dock with a recharge module; wherein the telescoping wand further includes a power module coupled to the body housing and configured to provide power to the components and modules of the portable viewing device;
b) a color camera coupled by a ball and joint swivel camera mount to the first end of the telescoping wand configured to rotate 180 degrees about the wand;
c) a display device in communication with the color camera and configured to display visual information therefrom; wherein the display device includes a storage module configured to store visual and audio information; wherein the display device further includes a power module configured to provide power thereto;
d) a docking station including a recharge module, coupled to the display device and configured to selectably couple to the first end of the telescoping wand, thereby allowing the wand to dock thereto and be recharged;
e) an audio module disposed within the body housing and configured to record audio information;
f) an adjustment mechanism having a locking mechanism coupled between the camera and the wand configured to secure the telescoping wand in an angled configuration;
g) an adapter module and a plurality of data transmission socket modules, configured to transmit visual and audio information to a display device; and
h) a carrying case configured to secure the telescoping wand, color camera, display device, and docking station for transportation of the portable viewing device.
